(19) United States
(12) Patent Application Publication
(10) Pub. No.: US 2014/0307305 A1
(43) Pub. Date: Oct. 16, 2014

(54) METHOD AND SYSTEM FOR CRYOCOOLED LASER AMPLIFIER

(71) Applicants: Robert J. Deri, Pleasanton, CA (US); Alvin C. Erlandson, Livermore, CA (US); Andrew J. Bayramian, Manteca, CA (US); Raymond J. Beach, Livermore, CA (US)

(72) Inventors: Robert J. Deri, Pleasanton, CA (US); Alvin C. Erlandson, Livermore, CA (US); Andrew J. Bayramian, Manteca, CA (US); Raymond J. Beach, Livermore, CA (US)

(21) Appl. No.: 14/122,901

(22) PCT Filed: Jun. 12, 2012
(86) PCT No.: PCT/US12/42097

§ 371 Date: Jun. 4, 2014

Related U.S. Application Data
(60) Provisional application No. 61/496,481, filed on Jun. 13, 2011.

(51) Int. Cl. H01S 3/042; H01S 3/16

(52) U.S. Cl. CPC H01S 3/042; H01S 3/1643; H01S 3/165
USPC 359/342

(57) ABSTRACT

A laser amplifier system includes a gain medium having a longitudinal axis and a plurality of sides substantially parallel to the longitudinal axis. The laser amplifier system also includes a waveguide having a plurality of inner surfaces. Each of the inner surfaces is optically coupled to one of the plurality of sides of the gain medium. The waveguide also includes a plurality of outer surfaces. The laser amplifier system further includes a cladding optically coupled to the outer surfaces of the waveguide.

### CROSS-REFERENCES TO RELATED APPLICATIONS

This application claims priority to U.S. Provisional Patent Application No. 61/496,481, filed on Jun. 13, 2011, entitled “Method and System for Cryocooled Laser Amplifier,” the disclosure of which is hereby incorporated by reference in its entirety for all purposes.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

Ytterbium-doped YAG (Yb:YAG) has been used as a solid state laser gain medium for high-power diode-pumped solid state lasers. Yb has a broad, 18 nm wide absorption band at 940 nm and produces gain at 1030 nm. Yb:YAG lasers and amplifiers can be used in some applications served by high-power 1064 nm Nd:YAG lasers/amplifiers and frequency doubling to 515 nm can enable use in some applications previously served by 514 nm argon ion lasers.

Despite the progress made in the development of solid state laser and amplifier systems, there is a need in the art for improved methods and systems related to solid state lasers.

### SUMMARY OF THE INVENTION

The present invention relates generally to laser systems. More specifically, the present invention relates to methods and systems for cryocooled laser amplifiers in which the gain medium is cooled to a predetermined temperature while the material used to absorb amplified spontaneous emission from the gain medium is operated at a higher temperature than the gain medium. Merely by way of example, the invention has been applied to a cryocooled amplifier assembly with thermally isolated edge absorbers. The methods and systems can be applied to a variety of other laser amplifier architectures and laser systems.

According to embodiments of the present invention, laser gain materials are operated at cryogenic temperatures while absorbing edge claddings are operated at higher temperatures, reducing the refrigeration requirements and thereby increasing system efficiency. In some embodiments, a cryocooled gain medium is utilized in which edge cladding used to absorb parasitic radiation such as ASE are operated at a warmer temperature. The thermal isolation can take the form of optical waveguides as well as free-space coupling between the gain medium and the edge cladding. Embodiments of the present invention are applicable to Yb as well as other cryocooled gain media and can be implemented in both reflective and transmissive amplifier geometries.

According to an embodiment of the present invention, a laser amplifier system is provided. The laser amplifier system includes a gain medium having a longitudinal axis and a plurality of sides substantially parallel to the longitudinal axis. The laser amplifier system also includes a waveguide having a plurality of inner surfaces. Each of the inner surfaces is optically coupled to one of the plurality of sides of the gain medium. The waveguide also has a plurality of outer surfaces. The laser amplifier system further includes a cladding optically coupled to the outer surfaces of the waveguide.

According to another embodiment of the present invention, a reflective optical amplifier is provided. The reflective optical amplifier includes a gain element having an input/output side and a back side. The gain element includes a gain medium having a width, a length, and a thickness less than the width and the length. The gain element also includes a waveguide partially surrounding the gain medium and an edge absorber partially surrounding the waveguide. The reflective optical amplifier also includes a reflective element disposed adjacent the back side and a cooling element disposed adjacent the reflective element.

According to a specific embodiment of the present invention, an optical amplifier system is provided. The optical amplifier system includes a set of amplifier units arrayed along a longitudinal direction. Each of the amplifier units includes a gain slab operable to amplify light propagating along the longitudinal direction and produce ASE along a transverse direction and a lateral direction. The transverse direction is orthogonal to the longitudinal direction and the lateral direction is orthogonal to the longitudinal direction and the transverse direction. Each of the amplifier units also includes a waveguide optically coupled to peripheral portions of the gain slab and a set of reflectors optically coupled to the waveguide and operable to reflect ASE propagating along the transverse direction. Each of the amplifier units further includes a set of cooling vanes. Each of the set of cooling vanes is coupled to one of the reflectors and operable to direct a cooling fluid flowing along the transverse direction. Each of the amplifier units additionally includes one or more absorptive edge claddings optically coupled to the waveguide and operable to absorb ASE propagating along the lateral direction. The optical amplifier system also includes a cooling system operable to provide a coolant flow along the transverse direction.

According to another specific embodiment of the present invention, a method of operating a laser amplifier is provided. The method includes providing a gain medium having a longitudinal axis, a transverse axis, and a lateral axis and pumping the gain medium. The method also includes directing light through the gain medium along the longitudinal axis and amplifying the light in the gain medium. The method further includes cooling the gain medium such that the gain medium is characterized by a first temperature and producing ASE in the gain medium. The ASE propagates along the transverse axis and the lateral axis. Additionally, the method includes directing the ASE through a waveguide optically coupled to the gain medium and absorbing a portion of the ASE in an edge cladding optically coupled to the waveguide. The cladding is characterized by a second temperature higher than the first temperature.

Numerous benefits are achieved by way of the present invention over conventional techniques. For example, embodiments of the present invention provide pulsed laser systems producing large pulse energies and operating at high repetition rates (i.e., high average power). In some embodiments, cooling of the gain medium improves the intrinsic laser efficiency and storage lifetime in comparison with conventional techniques. By reducing the amount of electrical power used to cool the amplified spontaneous emission absorber, embodiments of the present invention provide higher system efficiency than conventional systems. Some embodiments remove the absorbing edge cladding from the immediate vicinity of the gain medium, thereby significantly improving the system efficiency. These and other embodiments of the invention along with many of its advantages and features are described in more detail in conjunction with the text below and attached figures.

### BRIEF DESCRIPTION OF THE DRAWINGS

FIG. 1 shows simplified plots illustrating an inverse of a coefficient of performance as a function of temperature according to an embodiment of the present invention;

FIG. 2A shows simplified plots illustrating laser system efficiency as a function of peak pump power for Nd-doped glass gain medium in several cooling configurations according to an embodiment of the present invention;

FIG. 2B shows simplified plots illustrating laser system efficiency as a function of peak pump power for Yb:YAG gain medium at 200K in several cooling configurations according to an embodiment of the present invention;

FIG. 2C shows simplified plots illustrating laser system efficiency as a function of peak pump power for Yb:YAG gain medium at 150K in several cooling configurations according to an embodiment of the present invention;

FIG. 2D shows simplified plots illustrating laser system efficiency as a function of peak pump power for Yb:YAG and Nd:Glass gain medium at 200K and 150K in several cooling configurations according to an embodiment of the present invention;

FIG. 3A is a simplified schematic diagram illustrating an end view of an amplifier slab configuration with cryocooling according to an embodiment of the present invention;

FIG. 3B is a simplified schematic diagram illustrating a cross-section through the amplifier slab configuration illustrated in FIG. 3A.

FIG. 4 shows simplified plots illustrating conductive heat load through a waveguide for various configurations according to an embodiment of the present invention;

FIG. 5 is a simplified cross-sectional schematic diagram illustrating a tapered waveguide according to an embodiment of the present invention;

FIG. 6A is a simplified cross-sectional view of a waveguide configuration integrated with an actively cooled mirror according to an embodiment of the present invention;

FIG. 6B is a simplified end view of the waveguide configuration integrated with an actively cooled mirror illustrated in FIG. 6A;

FIG. 7A is a simplified end view of an amplifier slab geometry with cryocooling according to an embodiment of the present invention;

FIG. 7B is a simplified plan view of the amplifier slab geometry illustrated in FIG. 7A;

FIG. 7C is a simplified end view of an amplifier slab geometry with cryocooling and gas shaping according to an embodiment of the present invention;

FIG. 8A is a simplified end view of an amplifier slab geometry with flow barriers according to an embodiment of the present invention;

FIG. 8B is a simplified plan view of the amplifier slab geometry illustrated in FIG. 8A;

FIG. 9 is a simplified plan view of a waveguide configuration according to an alternative embodiment of the present invention;

FIG. 10A shows simplified plots illustrating Yb:YAG gain medium operated at 200K in several cooling configurations according to an embodiment of the present invention;

FIG. 10B shows simplified plots illustrating Yb:YAG gain medium operated at 150K in several cooling configurations according to an embodiment of the present invention;

FIG. 10C shows simplified plots illustrating laser system efficiency as a function of peak pump power for several system configurations according to an embodiment of the present invention; and

FIG. 11 is a simplified flowchart illustrating a method of operating an optical amplifier according to an embodiment of the present invention.

### DETAILED DESCRIPTION OF SPECIFIC EMBODIMENTS

High power solid-state lasers employ a pumped solid-state gain medium to provide optical gain. Scaling such lasers to higher power, and particularly to higher pulse energies in pulsed systems, involves the use of larger aperture gain media (i.e., a larger area transverse to the optical axis) in order to avoid limits imposed by the optical damage threshold of laser materials. As the aperture size X increases, the optical amplification gain G=e^{gX} for photons propagating transverse to the optical axis also increases. The resulting transverse amplified spontaneous emission (ASE) produces loss of energy stored in the gain medium and renders the system more susceptible to parasitic lasing in the transverse direction.

According to embodiments of the present invention, in order to suppress parasitic light and avoid parasitic lasing in the gain medium, transversely propagating ASE is prevented from making multiple passes through the gain medium, for example, through the use of an edge absorber with high optical loss at ASE wavelengths, also referred to as a cladding or an edge cladding. Some embodiments utilize a structure including treatment of the edge surfaces of the gain medium (e.g., AR coatings, beveled or ground surfaces, or the like). As more fully described throughout the present specification, the refractive index of the edge absorbers is typically closely matched to the refractive index of the gain medium to prevent back reflections.

The inventors have determined that conventional high energy pulsed laser amplifiers utilizing cryocooled, Yb-doped gain media do not offer significant advantages over Nd-doped gain media operated at room temperature if the ASE-absorbing edge cladding is also cryocooled. The efficiency-pump power tradeoff is worse for cryocooled media because of the inefficiencies associated with cooling at low temperatures. According to embodiments of the present invention, thermal decoupling of the edge cladding from the gain medium enables significant improvements in the efficiency-pump power tradeoff. Several designs provided by embodiments of the present invention are described herein that achieve the desired thermal decoupling and provide performance improvements over conventional systems.

When a laser is operated at high average power, a significant heat load is deposited in the edge absorbers. Some embodiments of the present invention relate to a laser amplifier beamline operating at a wavelength of 1053 nm and using a Nd doped glass gain medium. As an example of laser operation and heat load in the edge absorbers, to produce 6.33 kJ pulses from a 25×25 cm² aperture, a 1 J optical seed pulse makes four passes through a series of 32 glass slabs arranged as a pair of amplifiers. Each slab is 1 cm thick with an optical gain of 1.05. At this gain level, the slabs utilize a pump energy of 0.5 J/cm²/slab at 872 nm, and ASE results in approximately 294 J of energy being absorbed in the edge cladding of each amplifier slab. When operated at a pulse repetition rate of 15 Hz, this corresponds to a heat load of 4.4 kW into the edge absorber of each slab. Such high heat loads will generally require active cooling of the edge absorbers, which can be achieved, for example, by flowing cold fluid past the absorber to extract the heat.

Some embodiments of the present invention enable the use of cryogenically cooled gain media based on optical transitions of Yb ions. Such materials can provide improved optical efficiency (for example, due to their low quantum defect), and can enable lower system costs because their long excited state lifetime (≧1 ms) is compatible with longer pump durations in pulsed systems, which reduces the peak pump power requirement and thus the cost for diode pumps. Some work has been done related to the use of Yb in a YAG (yttrium aluminum garnet, Y₃Al₅O₁₂) crystal or ceramic host material and other work has related to the use of CaF₂ or sesquioxide hosts. Some of these hosts offer additional laser advantages associated with their attractive thermo-mechanical properties.

The inventors have determined that a fundamental disadvantage associated with most Yb-doped gain media is the requirement for cryogenic cooling. At room temperature, the quasi-3-level nature of the lasing transitions in Yb reduces the optical efficiency due to the thermal population of the lower lasing level. For this reason, very high pump intensity is required to achieve efficient operation with most Yb-doped media at room temperature. In practice, it is generally difficult to achieve such pump intensities. At sufficiently low temperatures, however, the inventors have determined that the thermal population of the lower lasing level is greatly diminished, so that Yb behaves as a 4-level system and the optical efficiency improves significantly.

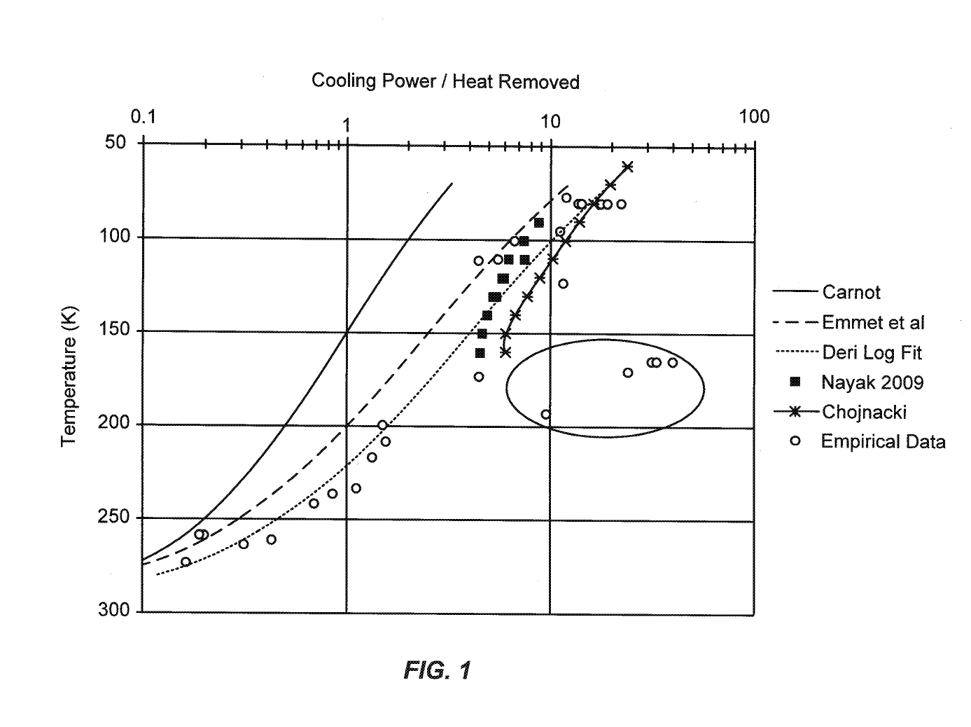

From a system perspective, the total laser wallplug efficiency should include the power required for cooling as well as the power required for optical pumping. Since refrigeration efficiency decreases with decreasing temperature, the improved optical efficiency of cryocooled Yb media is offset by the reduced efficiency of edge absorber cooling. The cooling efficiency is characterized by a “coefficient of performance” (COP), which is the ratio of the heat removed divided by the electrical power required to operate the cooling system. FIG. 1 shows simplified plots illustrating an inverse of the COP as a function of temperature according to an embodiment of the present invention. As illustrated in FIG. 1, the COP degrades rapidly with decreasing cooling temperature. The curves illustrated in FIG. 1 include measured and calculated data from several sources as well as the ideal Carnot refrigerator performance (solid line), a logarithmic fit to empirical data (Emmet et al), and another logarithmic fit to data points (Deli Log Fit). The data points circled at the right portion of the graph were not included in the fits. The large reductions in cooling COP illustrated in FIG. 1 can significantly degrade the overall wallplug efficiency of cryocooled laser systems in which the edge absorber is also cooled.

Conventional geometries for disk lasers locate the edge cladding in close proximity to the gain medium. Thin layers (mm scale) of adhesive might be employed to join these media, or they might be diffusion bonded together. In any case, the close proximity of the edge cladding and gain medium causes both materials to operate at very similar temperatures, so that the cooling subsystems for each (e.g., helium for slab faces and liquid for edge cladding) also operate at very similar temperatures.

The efficiency and pump power requirements of devices described herein can be computed to analyze laser performance. As an example, computations can be performed for an amplifier configuration operating at 6.33 kJ/pulse, using a 25×25 cm² aperture, and utilizing 4 passes. An Nd:Glass gain medium (e.g., APG-1 available from Schott) operating at room temperature or a cryocooled Yb-doped YAG gain medium operating at a temperature of either 150 or 200 K can be compared. The glass slabs are fabricated with a 1 cm thickness in some embodiments to avoid thermal shock issues, while the YAG thickness ranges to values of up to 2 cm in some embodiments to take advantage of its improved thermo-mechanical properties. In both cases, the number of amplifier slabs, gain coefficient per slab, and pump duration were varied to establish optimum regions of performance. Systems are compared on the basis of efficiency for fixed pump energy. In the computations described herein, the pump power is referenced to a system of 768 amplifier beamlines, each including 2 amplifier submodules, that produces a total of 4.9 MJ of 1.05 μm wavelength laser energy per pulse.

Laser performance was computed using a Frantz-Nodvik formalism, using cross-sections determined from experimentally reported, temperature-dependent absorption and emission spectra. The excited state lifetime parameters in the computations were obtained from experiments reported in the literature and ASE behavior was calculated using a method similar to that reported in the literature.

In order to remove heat generated within the bulk of the amplifier slab (e.g., heat generated due to quantum defect) a gas such as cold Helium gas is flowed at 5 atm. pressure. Heat in the edge absorber is removed by flowing a gas or liquid (e.g., a cold fluorocarbon liquid) through a contained region (e.g., tubing) that is thermally coupled to the edge absorbers. The cooling subsystems for both coolants (e.g., Helium gas and fluorocarbon liquid) are provided as a refrigeration loop that provides cooling via a heat exchanger to a secondary loop including a pump or compressor and the component being cooled. The electrical power for cooling includes both the pump/compressor power (assumed to be 75% of the ideal value) and the electrical refrigeration power, which was determined as a function of primary temperature (at the heat exchanger) using a curve fit to the COP data shown in FIG. 1. Other simulation parameters are summarized in Table 1, which provides a comparison of pulsed laser amplifier designs for various gain media. Embodiments of the present invention are not limited to these particular gain media, which are illustrated only for exemplary purposes. The Nd:Glass laser system illustrated in Table 1 includes 768 hemlines (1536 amplifiers) and delivers 4.9 MJ of energy at a wavelength of 1.05 μm.

TABLE 1

| Gain Medium | Nd: Glass | Yb: YAG | Yb: YAG |
|---|---|---|---|
| Temperature (K) | 295 | 200 | 150 |

Optical Output Parameters

| | | | |
|---|---|---|---|
| Optical output (kJ) | 6.33 | 6.33 | 6.33 |
| Repetition rate (Hz): | 15 | 15 | 15 |

Slab Configuration Parameters

| | | | |
|---|---|---|---|
| Number of slabs/beamline | 32 | 20 | 24 |
| Slab aperture (cm × cm) | 25 × 25 | 25 × 25 | 25 × 25 |
| Slab thickness (cm) | 1.0 | 2.0 | 2.0 |
| Gain coefficient (%/cm) | 10.0 | 8.8 | 9.5 |
| Passive loss/surface (%) | 0.2 | 0.2 | 0.2 |

Pump Parameters

| | | | |
|---|---|---|---|
| Pump power (GW/system) | 83.6 | 89.2 | 69.7 |
| Pump duration (ms) | 0.21 | 0.15 | 0.15 |
| Pump Efficiency | 73% | 73% | 73% |

Slab Heat Loads

| | | | |
|---|---|---|---|
| Bulk Heat (kW/slab) | 1.7 | 0.9 | 0.7 |
| Absorber Heat (kW/slab) | 4.4 | 3.2 | 2.0 |

Laser System Efficiency

| | | | |
|---|---|---|---|
| Without cooling | 13.7% | 16.8% | 21.3% |
| With cooling | 10.3% | 10.2% | 8.2% |

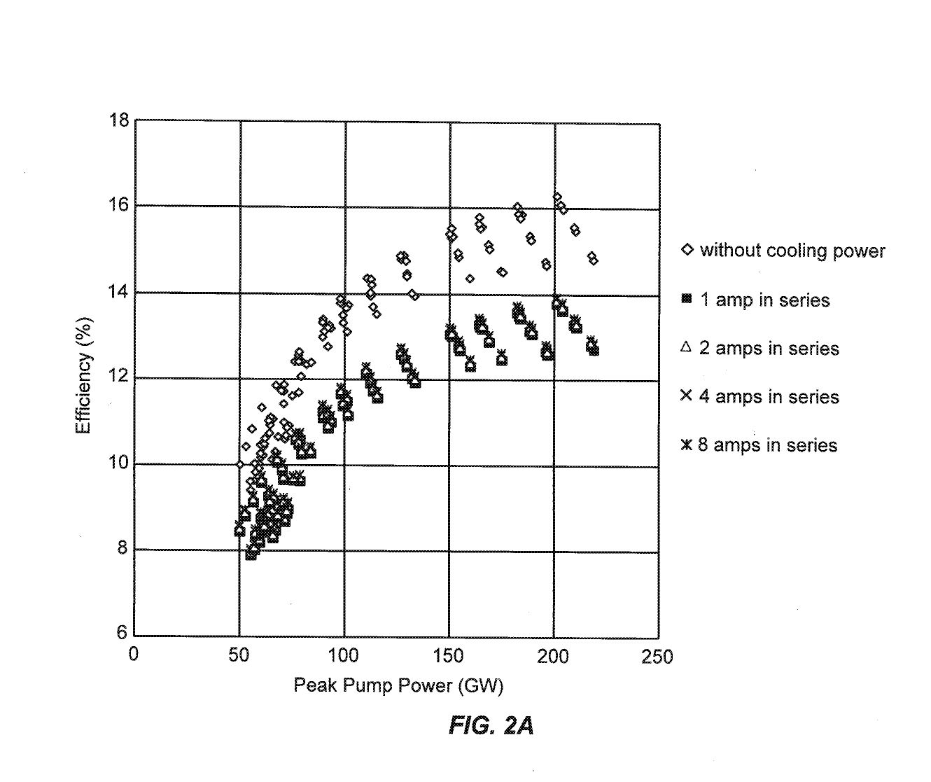

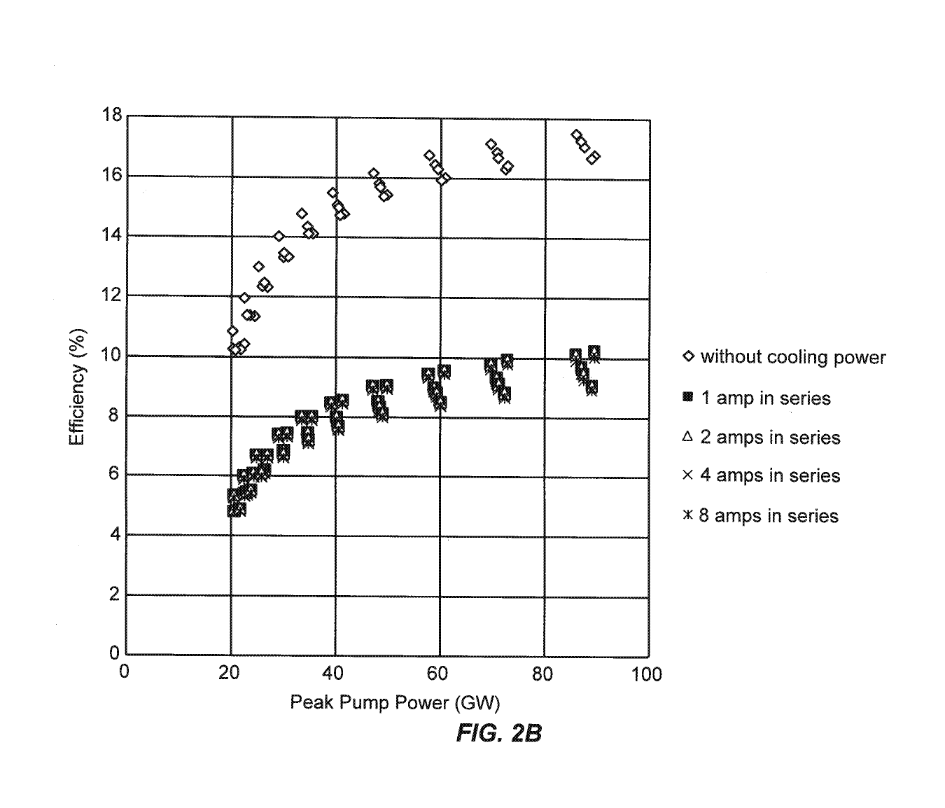

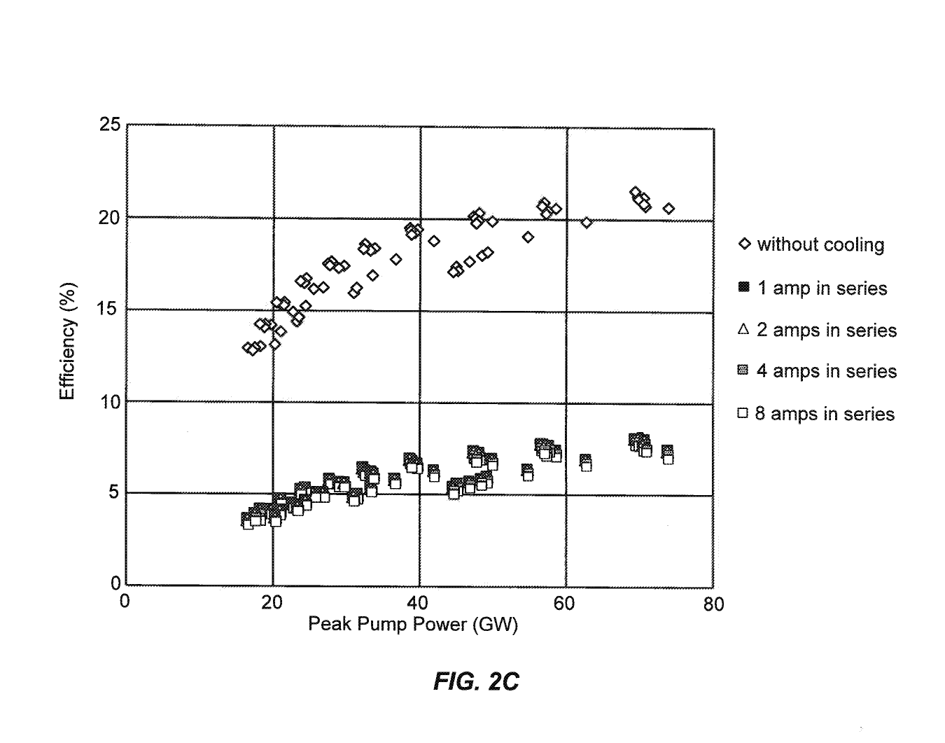

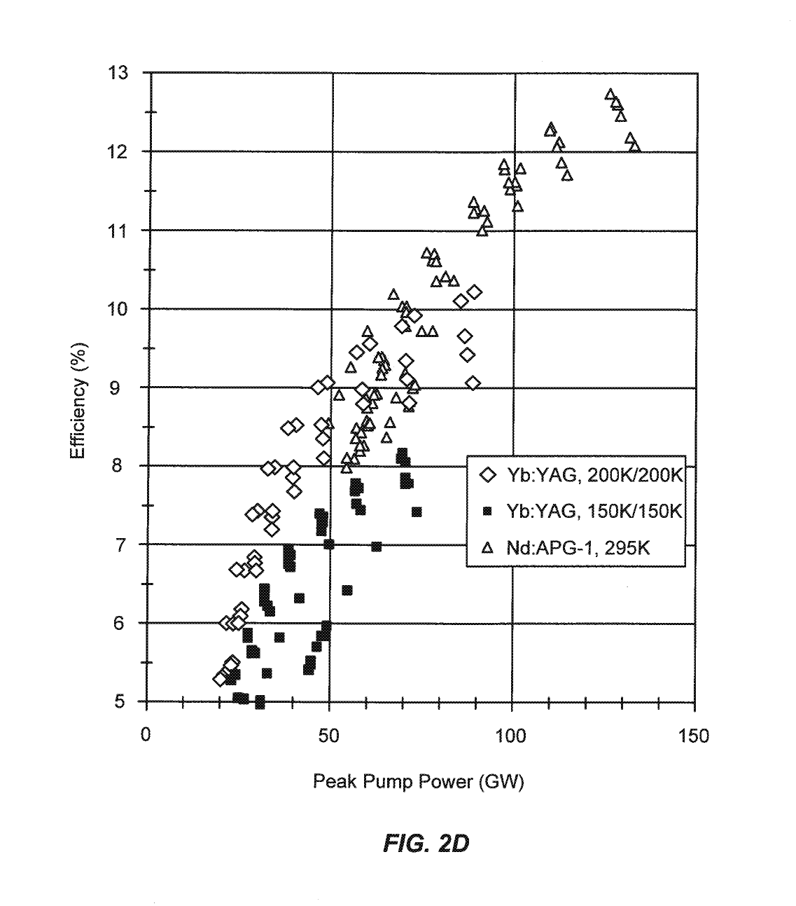

FIG. 2A shows simplified plots illustrating laser system efficiency as a function of peak pump power for Nd-doped glass gain medium in several cooling configurations according to an embodiment of the present invention. FIG. 2B shows simplified plots illustrating laser system efficiency as a function of peak pump power for Yb:YAG gain medium at 200K in several cooling configurations according to an embodiment of the present invention. In FIGS. 2A and 2B, each data point represents a different laser design.

Referring to FIG. 2A, efficiency as a function of peak pump power is shown for a 25 cm×25 cm Nd:APG-1 amplifier slab operated at 295K (near room temperature). Operation without cooling power, and for one through eight amplifier slabs in series are illustrated. Referring to FIG. 2B, efficiency as a function of peak pump power is shown for Yb:YAG amplifier slab(s) operated at 200K, with an edge cladding operated at 200K. Operation without cooling power, and for one through eight amplifier slabs in series are illustrated. Thus, the figures show results for both the total system efficiency (including cooling subsystems) and for the laser alone (without cooling). FIGS. 2A and 2B illustrate the fundamental tradeoff between system efficiency and the required pump power, which represents the required cost of diode pump components. The tradeoff is adjusted by varying the duration of the pump pulse. These figures show that the use of a cooled Yb gain medium significantly reduces the required pump power, which results, in part, from the substantially longer excited state lifetime of the Yb ions in comparison with Nd ions (˜1 ms for Yb vs. ˜250 μs for Nd). In some embodiments, the reduction in pump power is accompanied by a decrease in overall system efficiency. As shown in Table 1, the required pump power for the cryocooled Yb:YAG system at 200K is ˜89 GW, achieving comparable efficiency to that of the Nd:Glass system, for example 10%.

FIG. 2C shows simplified plots illustrating laser system efficiency as a function of peak pump power for Yb:YAG gain medium at 150K in several cooling configurations according to an embodiment of the present invention. The edge cladding is also operated at 150K in the embodiment illustrated in FIG. 2C. The above figures demonstrate that some embodiments of cryocooled systems operate at efficiencies less than 10% when the laser is operated in a high energy pulsed mode of operation. In the illustrated embodiments, while systems with cryocooled gain media exhibit better performance than the room temperature, glass-based design when cooling is not considered, the increased electrical power needed for cryogenic cooling results in an overall net reduction in system efficiency.

FIG. 2D shows simplified plots illustrating laser system efficiency as a function of peak pump power for Yb:YAG and Nd:Glass gain medium at 200K and 150K in several cooling configurations according to an embodiment of the present invention. The gain medium and the edge absorber are maintained at the same temperature (i.e., 200K/200K or 150K/150K). Only total laser system efficiency including cooling is shown. The comparison between cryocooled Yb:YAG laser systems and a room-temperature Nd:glass system shown in FIG. 2D illustrates that although some embodiments of the cryocooled systems offer improved performance at low pump power and system efficiency, little or no advantage is achieved by employing the cryocooled media in these embodiments when system efficiency>9% is required.

Thus, the inability to achieve efficiencies>10% limits the use of conventional cryocooled systems based on Yb-doped gain media in certain applications, including inertial fusion energy power plants, which can utilize high-energy pulsed lasers with efficiencies of 10% or greater.

As discussed above, the overall efficiency of high-energy, pulsed laser systems based on cryocooled, Yb-doped gain media is significantly impacted by the cooling requirements. Referring again to Table 1, it is apparent that the cryogenic heat load is dominated by heating of the edge cladding due to transverse ASE in the amplifier slabs, which is significantly greater than the bulk (volumetric) slab heating due to the quantum defect and nonradiative decay. Since the electrical power required to remove this heat from the cladding depends strongly on the operating temperature of the cooling system, the overall system efficiency could be improved by operating the edge cladding absorber near room temperature. In some embodiments, the edge cladding absorbers can be operated at temperatures above, at, or below room temperature as appropriate to the particular application using water cooling or other suitable cooling system. This is not practical for conventional devices, in which the edge cladding is in close proximity to the cold gain material, because of limitations associated with thermal stresses and the parasitic heat leakage into the slab. Thus, embodiments of the present invention utilize device geometries that thermally decouple the edge cladding from the gain material, enabling the cladding to be operated at higher temperatures than the gain medium.

As described more fully throughout the present specification, some embodiments of the present invention insert a region of transparent material between the gain medium and the edge cladding, to both provide thermal isolation and serve as a waveguide that directs ASE from the gain medium to the edge cladding.

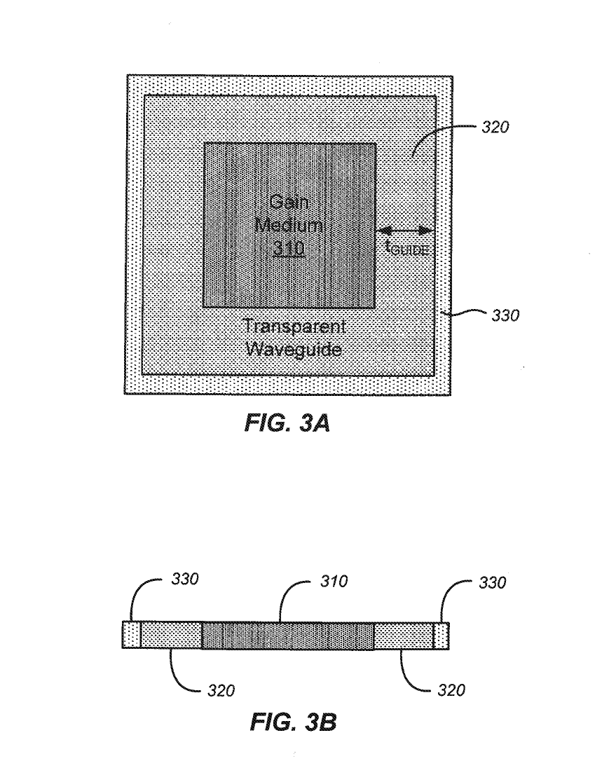

FIG. 3A is a simplified schematic diagram illustrating an end view of an amplifier slab configuration with cryocooling according to an embodiment of the present invention. FIG. 3B is a simplified schematic diagram illustrating a cross-section through the amplifier slab configuration illustrated in FIG. 3A. As illustrated in FIG. 3A, a gain medium 310 is partially surrounded by a transparent waveguide 320 with a width equal to t_{GUIDE}. An edge cladding 330 partially surrounds the transparent waveguide 320. The refractive index of the waveguide 320 is closely matched to those of both the cladding 330 and the gain medium 310 to prevent parasitic lasing in the plane of the slab, which lies in the plane of the figure for FIG. 3A. The surfaces of the transparent waveguide 320 (e.g., the top surface shown in FIG. 3B) can be polished so that some ASE is confined to the waveguide material by total internal reflection. By selecting a sufficiently large waveguide width t_{GUIDE}, the waveguide provides thermal isolation so that the gain medium and cladding can operate at very different temperatures.

In some embodiments, characteristics of the waveguide structure include:

1. High transparency at the lasing wavelength (e.g., typically ˜1050 nm in some embodiments and ˜1030 nm in other embodiments such as those using Yb-based gain media). Transparent, as used herein, includes low absorption that can be less than 100% transmission. Therefore, transparent is not intended to denote 100% transmission, but a high transmission and low absorption at wavelengths of interest, for example, an absorption coefficient (i.e., power absorption) less than 10%, less than 9%, less than 8%, less than 7%, less than 6%, less than 5%, less than 4%, less than 3%, less than 2%, less than 1%, less than 0.5%, less than 0.25%, less than 0.1%, less than 0.05%, less than 0.025%, or less than 0.01%. Thus, the use of the term “transparent” in the description does not require 100% transmission of the wavelengths of interest, but should be understood to include materials that pass a majority or substantially all of the wavelengths of interest.
2. Refractive index matched to both cladding and gain medium, typically to within 0.05 or better (depending on the gain coefficient and dimensions of the amplifier slab)
3. Sufficiently wide t_{GUIDE} so that the heat load on the amplifier slab due to conductive heat flow from the cladding to the gain medium is small, compared to other heating loads on the amplifier slab. This heat load can be expressed by the equation: 4 t X K ΔT/t_{GUIDE}<<Q_{SLAB}, where X and t are the aperture width and thickness of the gain medium, K is the thermal conductivity of the waveguide material, ΔT is the temperature difference between cladding and gain medium, and Q_{SLAB} is the volumetric heating of the amplifier slab due to quantum defect and nonradiative decay.
4. Sufficient waveguide width t_{GUIDE} to avoid thermal stresses that could fracture or warp the assembly.
5. Thermal expansion coefficient sufficiently well matched to gain medium to avoid thermal fracture or warpage.
6. The waveguide material should be opaque in the far infrared, to prevent radiative heat transport. For edge cladding temperatures near room temperature, the cladding thermal spectrum is peaked at approximately 9.7 μm. Thus, some embodiments utilize waveguide material with a transparency cutoff wavelength of ˜4 μm.

The materials selected for the waveguide and the edge cladding depend on the material chosen to provide laser gain. In the exemplary embodiment that follows, material options for two gain medium hosts are presented: YAG ceramic and CaF₂ crystal.

Yb:YAG Gain Material

For Yb:YAG gain material, with an index of refraction of ˜1.82, the waveguide material can be fabricated from undoped YAG ceramic, a high refractive index glass (e.g.; Schott LaSF), or other suitable index-matched materials with similar coefficients of thermal expansion. The edge cladding can be fabricated using the same host materials doped with absorbing metal ions, such as copper, cobalt, or the like. An advantage of using YAG for both the waveguide and the cladding is a near-perfect match of the thermal expansion coefficient, which will avoid thermal stress in the assembly. Another advantage provided by YAG waveguide and cladding material is that these materials can be direct bonded to the amplifier slab using an adhesive-free, co-sintering process. Use of a glass material for the waveguide can include the use of an optical adhesive with refractive index ˜1.82. One option for such an adhesive involves loading the adhesive with high refractive index nanoparticles, which has achieved indices>1.84. An advantage provided by glass waveguides is a substantially reduced thermal conductivity, which reduces the parasitic heat flowing through the waveguide. The infrared transmission cutoff wavelengths (imaginary index>1×10⁻⁴) of YAG and glass are ˜4 μm and ˜2 μm, respectively, so both materials will inhibit direct radiative transport.

Yb:CaF₂ Gain Material

For Yb:CaF₂ gain material, with an index of refraction of ˜1.42, the waveguide and cladding can be fabricated from CaF₂, glass, a polymer material, or the like. The edge cladding can be fabricated from glass doped with absorbing metal ions, as discussed above. CaF₂ is characterized by a relatively high thermal expansion coefficient of 18 ppm/K. Accordingly, some embodiments address thermal stresses in the waveguide/amplifier slab assembly induced by cryocooling. For example, glasses with reasonable index matching (e.g.; N-FKS available from Schott) exhibit a significant expansion coefficient mismatch (12.7 ppm/K). While waveguides fabricated from CaF₂ avoid this issue, solutions based on other materials remain attractive due to the relative mechanical fragility of CaF₂. Some embodiments of the present invention mitigate thermal expansion mismatch issues by utilizing a nested series of waveguide layers, including glass (e.g.; N-FKS) separated by moderately thin layers (e.g., ˜1 mm) of a compliant optical adhesive. Most of the mismatch strain will be applied to the interleaved adhesive due to its low modulus. With sufficient adhesive intrinsic compliance and sufficient bonding strength at the interfaces, this design can accommodate large stresses.

Although the geometry illustrated in FIG. 3A utilizes an absorbing material (i.e., the edge cladding) that is in close proximity (i.e., attached) to the waveguide, this is not required by the present invention. In other embodiments, an antireflection (AR) coating is applied to the waveguide end surfaces so that light is propagated outside the amplifier slab to remotely located absorbing beam dumps.

The width of the absorbing edge cladding 330 is selected so that the effective reflectivity from the outer surface of the edge cladding is sufficiently low. This reflectivity is reduced by twice the single-pass absorption through the cladding, which is e^{-2α′L} for cladding absorption coefficient α′ and thickness L. At the same time, thermal transport between the edge cladding and the liquid cooling system (which can be thermally connected to only the outer edge of the edge cladding in embodiments in which multiple amplifier slabs are stacked close together) enhanced by a thinner edge cladding. In some embodiments, the edge cladding thickness will range from about 0.1 mm to about 5 mm. In a particular embodiment, the edge cladding thickness is L≈1 mm.

Referring once again to Table 1, the waveguide width t_{GUIDE} providing sufficient thermal isolation was calculated for a geometry of a 25 cm aperture, 2 cm thick amplifier slab using temperature-dependent thermal conductivities. The temperature-dependent thermal conductivity for ceramic YAG assumes a ceramic grain size of 4 μm. The temperature-dependent thermal conductivity of LaSF glass was used for the thermal conductivity of glass (1.06 W/m-K at 35° C.).

Although Yb:YAG and Yb:CaF₂ gain materials are discussed above, embodiments of the present invention are not to these materials and other suitable host materials can be used, including glass, strontium fluoroapatite (SFAP), or the like. One of ordinary skill in the art would recognize many variations, modifications, and alternatives. Additionally, although Yb has been discussed herein as a suitable rare earth gain medium, other gain media suitable for operation at cryocooled temperatures can be utilized to provide laser systems with thermally isolated edge claddings providing high efficiency.

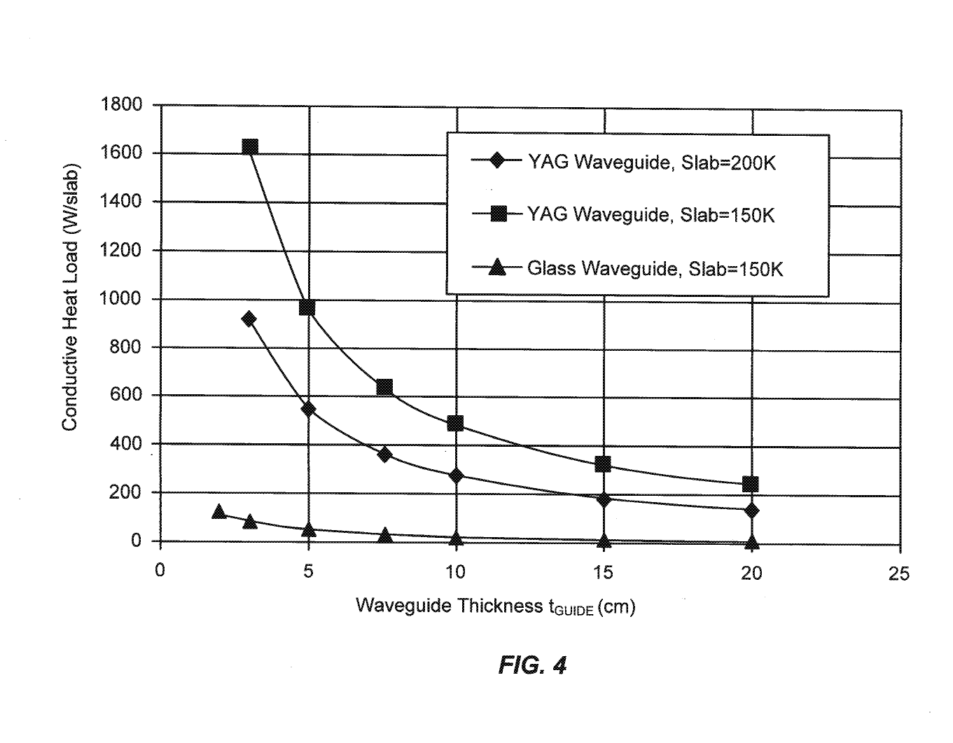

FIG. 4 shows simplified plots illustrating conductive heat load through a waveguide for various configurations according to an embodiment of the present invention. The heat loads shown in FIG. 4 were calculated using 4 times the heat flux across a 25 cm×2 cm waveguide cross-section (25 cm×25 cm amplifier slab of 2 cm thickness) calculated from a 1-D finite element simulation. Since typical bulk heat loads on the amplifier slabs due to quantum defect and nonradiative processes are ˜900 W (see Table 1), embodiments of the present invention utilize waveguide widths that range from about 10 cm to 15 cm for YAG and about 3 cm to 5 cm for glass.

In some embodiments, minimization of the waveguide width t_{GUIDE} is desired in order to reduce the overall size of the laser system. Size reduction can be achieved through several approaches:

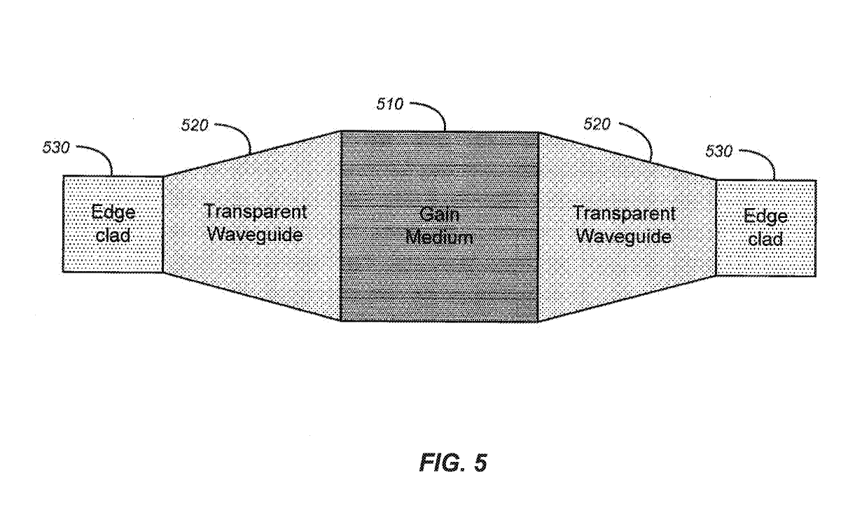

1. Tapering the dimension of the guiding layer along the heat propagation direction, thereby reducing the effective cross section for thermal transfer and enabling smaller waveguides or reduced conductive heat loads. FIG. 5 is a simplified cross-sectional schematic diagram illustrating a tapered waveguide according to an embodiment of the present invention. As illustrated in FIG. 5, the cross section of the waveguide 520 at its junction with the gain medium 510 (i.e., an amplifier slab) is matched to the gain medium, but the waveguide dimension along the axis orthogonal to the direction of propagation can taper down towards the edge cladding 530. For example, tapering from a 2 cm×25 cm cross-section at the gain medium to 1 cm×25 cm cross-section at the edge cladding reduces the heat load by ˜25%. As an example, a tapered ceramic YAG waveguide can be used to reduce heat conduction into the gain medium.
2. By operating the edge cladding at a slightly reduced temperature (e.g., 280 K)
3. By constructing the waveguide from material with lower thermal conductivity. For example, for ceramic YAG waveguides, there is a slight advantage to using material with a smaller grain size, because this reduces the thermal conductivity. Doping the waveguide material with species that have a significantly different atomic mass or bond strength than the host material (to induce phonon scattering centers) can also be used to reduce its thermal conductivity, particularly at low temperatures.

The worst-case thermo-mechanical stress for an expansion-matched waveguide/gain medium pair can be estimated from

σ_{MAX}=E αΔT/(1−v),

where E is Young's modulus, a is the thermal expansion coefficient, v is Poisson's ratio, and ΔT is the temperature difference. Using material coefficients for ceramic YAG, the estimated maximum stress is below 150 MPa for an amplifier slab at 200K. This estimate is a worst-case value because it assumes a rigidly constrained assembly and a temperature-independent expansion coefficient. Practical assemblies will be loosely held to avoid thermo-mechanical issues, and α is known to decrease with decreasing temperature, so that the effective expansion strain ∫α dT<α ΔT. Since the worst case estimate of σ_{MAX}=150 MPa is well below the fracture strength of ceramic YAG (340-360 MPa) and the elastic limit of crystal YAG (280 MPa), and given the conservative nature of the σ_{MAX} estimate, the thermal gradient across the waveguide does not appear to be a significant issue.

An additional advantage of operating the edge cladding at higher temperatures is the improved performance of liquid coolants. Cooling liquids are available with pour points as low as 135 K, but their viscosity is significant when operated at temperatures within a few tens of degrees Kelvin above the pour point. Higher viscosity increases the electrical power required to pump the fluids. In contrast, operation near room temperature enables the use of very effective coolants (e.g., water, water/glycol brines, and the like) that exhibit low viscosity, excellent thermal capacity, and low cost.

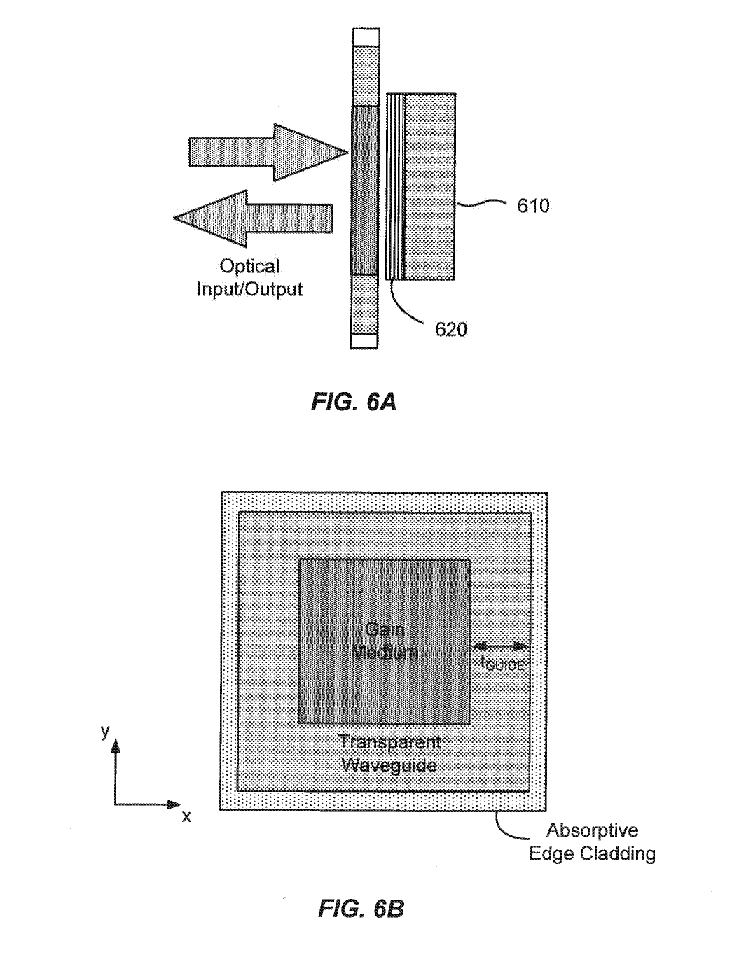

FIG. 6A is a simplified cross-sectional view of a waveguide configuration integrated with an actively cooled mirror according to an embodiment of the present invention. FIG. 6B is a simplified end view of the waveguide configuration integrated with the actively cooled mirror illustrated in FIG. 6A. The waveguide configuration illustrated in FIGS. 6A and 6B are suitable for designs in which the laser beam enters and exits the amplifier slab through the same face. Thus, one face of the amplifier slab can be used for cooling as shown in FIG. 6A.

A cooling medium 610, which can be either a liquid coolant or solid, thermally conductive block, is located in close proximity to the amplifier slab face. In the illustrated embodiment, the cooling medium 610 is separated from the gain medium by a reflective coating 620, which can be a high reflectance (HR) multi-layer dielectric stack. As shown in FIG. 6A, the transverse dimensions of the cooling block (in the x-y plane aligned with the plane of FIG. 6B) is smaller than the amplifier slab/transparent waveguide/edge cladding assembly so that the low-temperature cooling medium does not provide a thermal “short circuit” across the waveguide. Because of the thermal isolation between the gain medium and the edge cladding, the gain medium can be cooled as needed separately from the edge cladding, which can operate at a higher temperature than the gain medium.

When faces of the amplifier slab are accessible for direct cooling with fluids, the gain medium can be cooled by flowing high pressure gas over its faces. Several implementation details of this approach include:

1. Helium gas can be used to minimize scattering losses.
2. The amplifier slabs and their cover windows, or their reflectors for reflective geometries such as FIG. 6A, are typically arrayed to form narrow gas flow channels that increase the gas velocity to improve heat transfer directly over the channel.
3. The gas inlets and outlets to the gain medium channels are shaped with “vanes” to achieve the optimal flow patterns.

For this cooling approach, some waveguide configurations are suboptimal, because the gas coolant may be heated as it passes over the higher temperature edge cladding. This increases the heat load on the refrigeration system and will, therefore, reduce system efficiency.

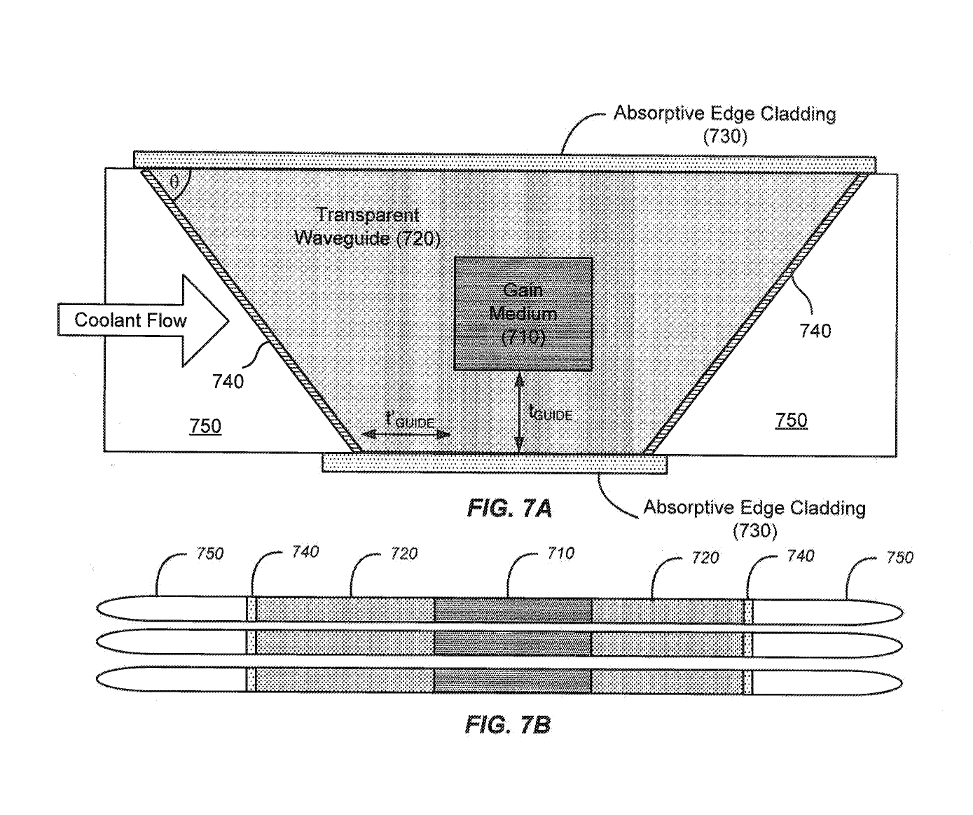

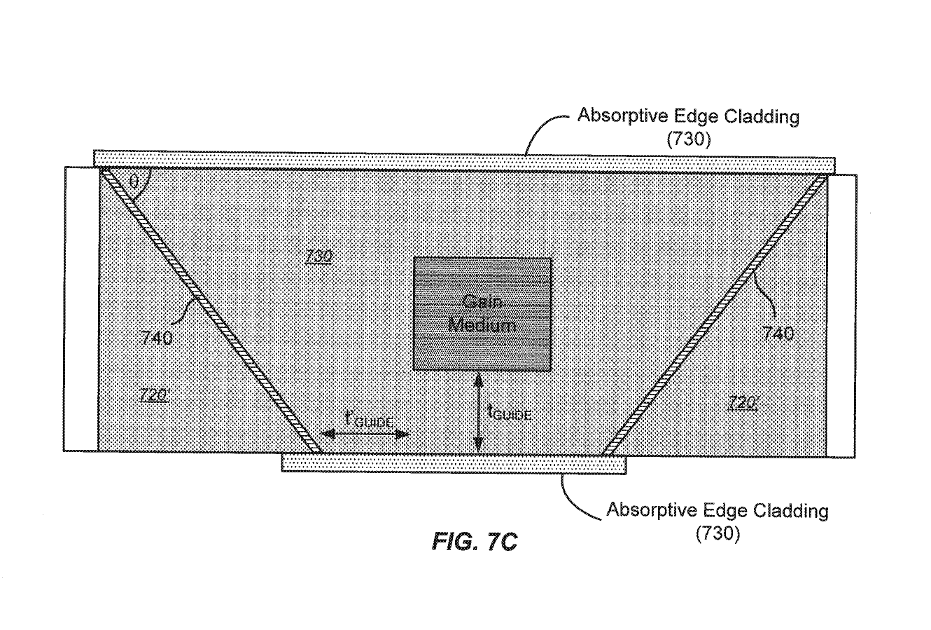

FIG. 7A is a simplified end view of an amplifier slab geometry with cryocooling according to an embodiment of the present invention. FIG. 7B is a simplified plan view of the amplifier slab geometry illustrated in FIG. 7A. The waveguide configuration illustrated in FIG. 7 utilizes reflectors 740 to deflect ASE to absorbing edge claddings 730 located on only two edges of the amplifier slab assembly. The reflectors 740 can be fabricated by depositing HR coatings on the angled edges of the waveguide material 720. As illustrated, the reflectors 740 are tilted at an angle θ to direct the ASE into the absorptive edge cladding. These edges are connected to gas shaping vanes 750 in FIGS. 7A and 7B to ensure proper gas flow, which can be made of non-optically transparent material. The bonding of the gas shaping vanes 750 can be performed using a variety of materials, including epoxy, since there is no requirement for index matching or transparency. The gain slab 710, waveguide material 720, reflectors 740, gas shaping vanes 750, and absorptive edge claddings 730 can be referred to as an amplifier unit. In the illustrated embodiment, the amplifier units are arrayed in the longitudinal direction along which laser light is amplified during propagation through the set of amplifier units. The thermal separation between the absorptive edge cladding and the gain medium enables the gain medium to be operated at a first temperature (e.g., cryogenic temperatures) while the absorptive edge claddings are operated at a second temperature (e.g., room temperature) higher than the first temperature.

As illustrated in FIG. 7A, the coolant flow provides flow of the coolant to the gain medium in a manner in which some or a majority of the coolant flow does not interact with the edge cladding. The central portion of the coolant flow does not flow over the edge claddings before reaching the gain medium, but flow parallel to the edge claddings. Therefore, in this embodiment, because the edge claddings are located at the peripheral portions of the assembly parallel to the coolant flow, an additional level of thermal decoupling between the edge absorbers and the gain medium is provided.

FIG. 7C is a simplified end view of an amplifier slab geometry with cryocooling and gas shaping according to an embodiment of the present invention. As illustrated in FIG. 7C, additional waveguide material 720′ is used to form a waveguide edge parallel to the plane of FIG. 7C. The use of additional waveguide material 720′ may simplify bonding and reduce thermal stresses.

Referring to FIG. 7A, the reflecting surfaces and edge cladding are arranged in order to prevent parasitic lasing in the transverse plane (the plane of FIG. 7A) and to minimize ASE-induced loss of excited state energy in the gain medium. As illustrated, the HR coated edges are not oriented parallel to one another to avoid formation of a lasing cavity. In some embodiments, the distance t′_{GUIDE} is set at a sufficiently large distance and the angle θ is set at a sufficiently small angle so that ASE emitted from the gain medium at most angles in the plane of FIG. 7A does not reflect from the HR coatings back into the gain medium.

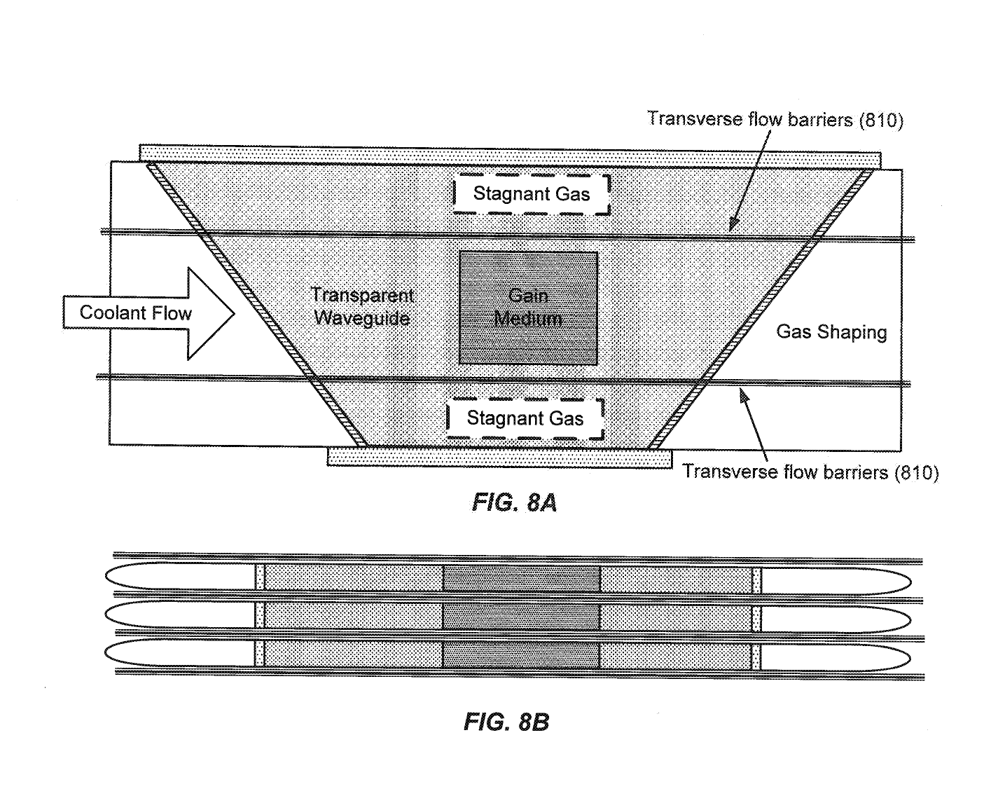

Because the assembly temperature will vary appreciably in the direction transverse to the gas flow, improved cooling performance can be achieved by preventing lateral transport of the cooling gas as it traverses the assembly. For typical gas velocities of 50 to 100 m/s, there should be only moderate lateral diffusion during the ˜10 ms during which the gas flows across the waveguides and slabs. FIG. 8A is a simplified end view of an amplifier slab geometry with flow barriers according to an embodiment of the present invention. FIG. 8B is a simplified plan view of the amplifier slab geometry illustrated in FIG. 8A. The flow barriers 810 illustrated in FIG. 8A reduce residual transport. It should be noted that in some embodiments, the flow barriers need not support a high pressure differential or make a leak tight seal. By maintaining similar gas pressure on both sides of the barrier, the barrier provides a geometric obstacle to lateral flow.

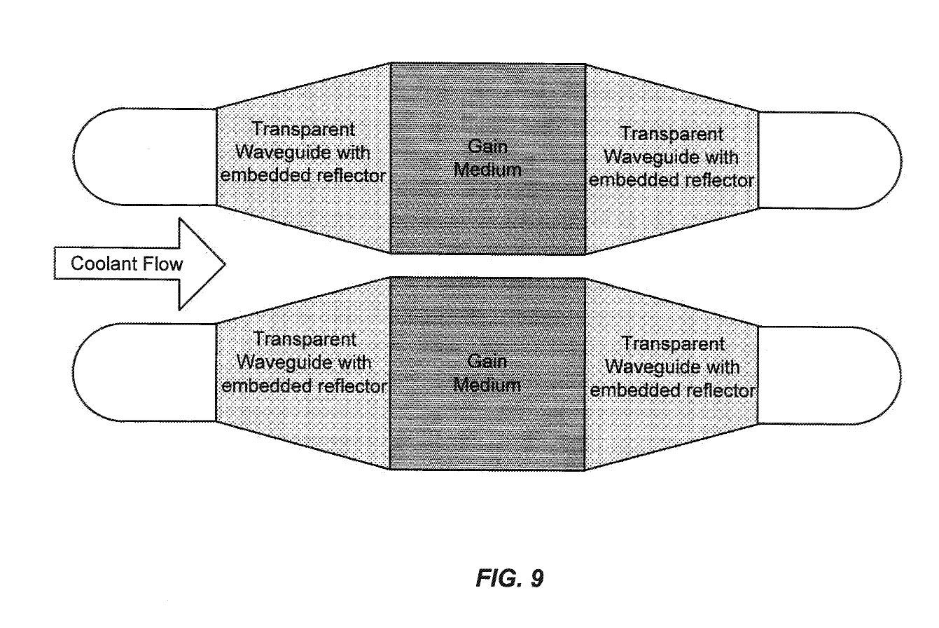

FIG. 9 is a simplified plan view of a waveguide configuration according to an alternative embodiment of the present invention. The cross-section illustrated in FIG. 9 is similar to the cross-section illustrated in FIG. 8B. The increased length of waveguide material along the coolant flow path will increase the pressure drop across the assembly. This increased pressure drop is undesirable, because it increases the electrical power consumed by the compressor that drives the gas coolant through the amplifiers. The configuration illustrated in FIG. 9 mitigates the pressure drop by tapering the waveguide along the flow direction. By increasing the width of the coolant flow channel away from the gain medium, the fluid velocity and friction in this region are reduced. In addition, the configuration illustrated in FIG. 9 reduces the thermal conductivity of the transparent waveguide, thereby decreasing the thermal conduction between the edge claddings and the gain medium.

The inventors have developed system simulations to demonstrate that cryocooled lasers/amplifiers with room temperature absorbers provide attractive performance enhancements over room-temperature Nd:glass lasers/amplifiers. The improved coefficient of performance of the edge cladding cooling system reduces the cooling electrical power, resulting in net improvement of the system efficiency.

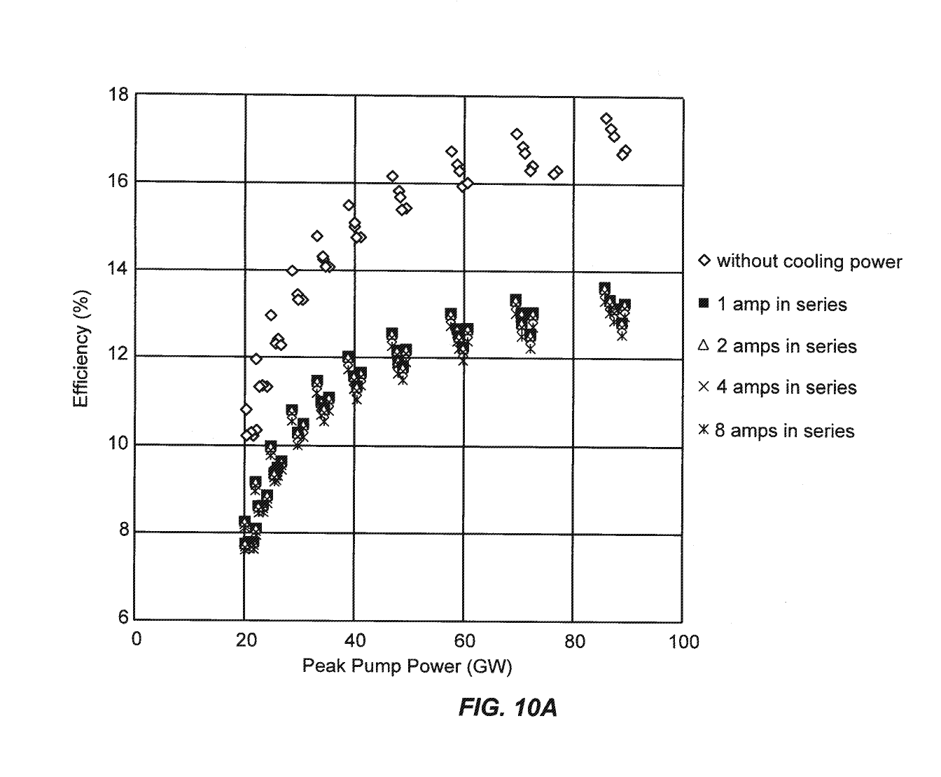

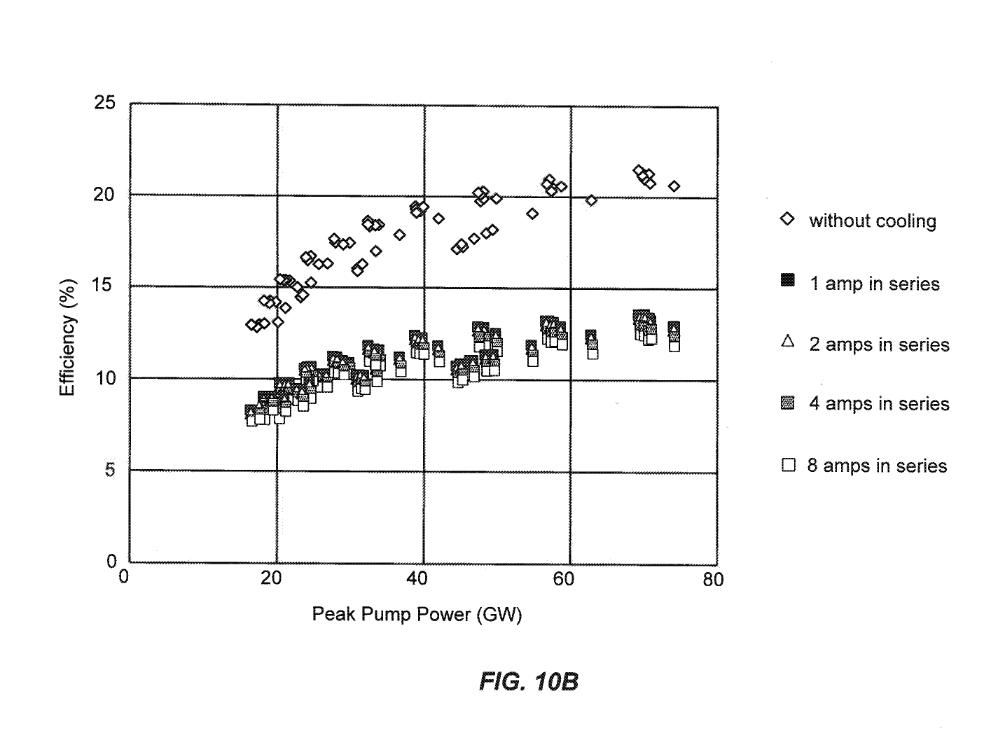

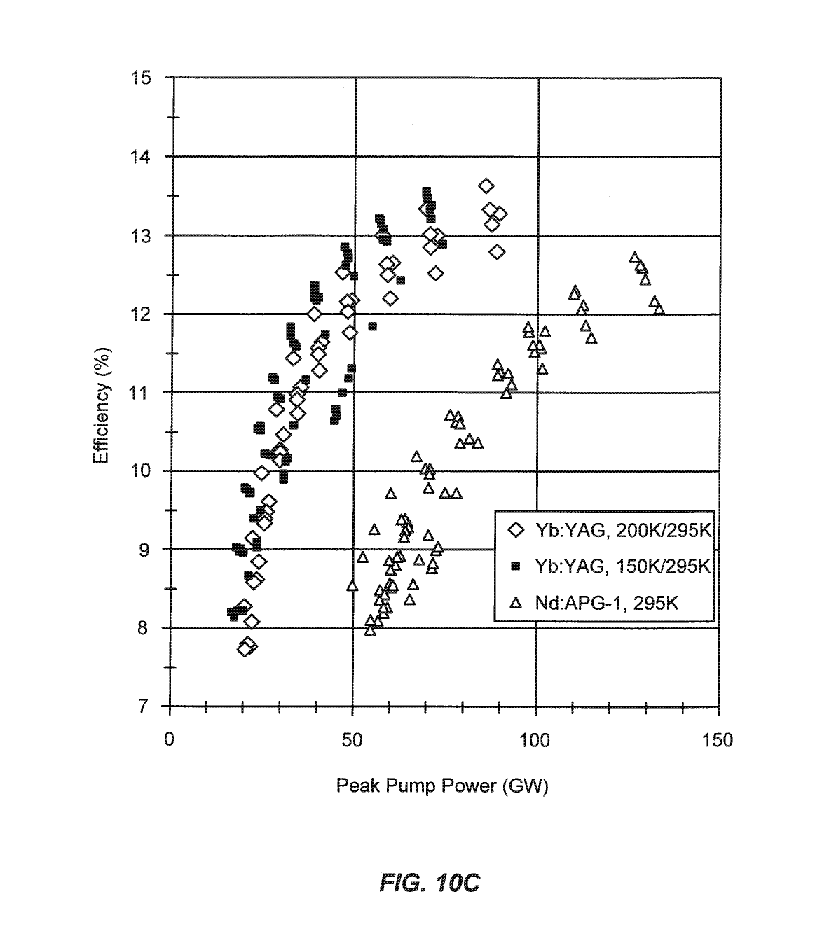

FIG. 10A shows simplified plots illustrating Yb:YAG gain medium operated at 200K in several cooling configurations according to an embodiment of the present invention. FIG. 10A illustrates the efficiency-pump power tradeoff for a laser based on Yb:YAG amplifier slabs operated at 200K with edge claddings operated at 295K. FIG. 10B shows simplified plots illustrating Yb:YAG gain medium operated at 150K in several cooling configurations according to an embodiment of the present invention. FIG. 10B illustrates the efficiency-pump power tradeoff for a laser based on Yb:YAG amplifier slabs operated at 150K with edge claddings operated at 295K.

The laser parameters used to compute the plots in FIGS. 10A and 10B are identical to those listed in Table 1. The only difference from the earlier results is that the edge cladding is operated at 295K (i.e., approximately room temperature) instead of cryogenic temperatures. At pump powers in the >80 GW range, the 200K Yb:YAG system efficiency is above 13%, as compared to ˜10% for Nd:glass systems with the same pump power (see Table 1). Achieving 10% efficiency only requires ˜25 GW of pump power (as compared to 82 GW with Nd:glass). Therefore, embodiments of the present invention utilize room-temperature operation of ASE absorbers to enable 200K cryocooled Yb:YAG lasers that can improve laser efficiency by ˜3% (at fixed pump power) or reduce pump power by approximately a factor of three (at a fixed efficiency of 10%).

FIG. 10C shows simplified plots illustrating laser system efficiency as a function of peak pump power for several system configurations according to an embodiment of the present invention (i.e., Yb:YAG amplifier slabs operated at 200K with edge absorbers operated at 295K and Yb:YAG amplifier slabs operated at 150K with edge absorbers operated at 295K). As illustrated in FIG. 10C cryocooled gain media with edge absorbers operated at higher temperatures (e.g., room temperature) can offer significant improvements over room-temperature Nd:glass lasers. The data shown in FIG. 10C demonstrates that operation of the Yb:YAG amplifier slabs at 150K and 200K results in similar system performance. Therefore, given that lower temperature operation typically requires additional system costs and complexity, some embodiments are preferably operated at a temperature of 200K. One of ordinary skill in the art would recognize many variations, modifications, and alternatives.

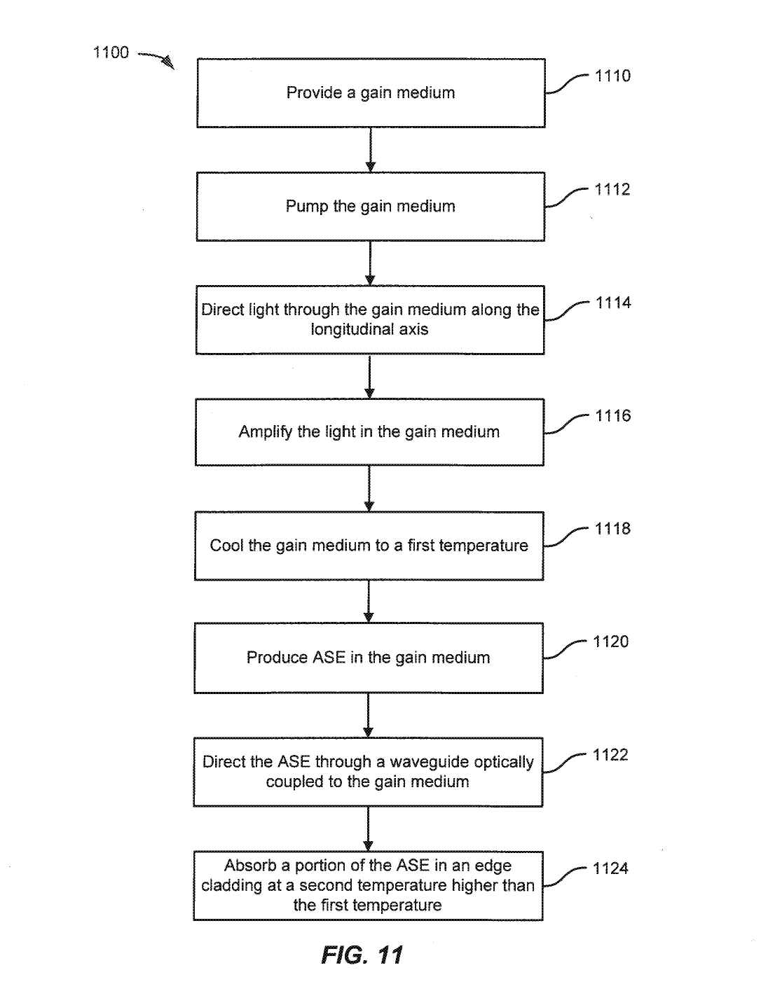

FIG. 11 is a simplified flowchart illustrating a method of operating an optical amplifier according to an embodiment of the present invention. The method 1100 includes providing a gain medium (e.g., an Yb-based amplifier medium such as Yb:YAG or Yb:CaF₂) having a longitudinal axis, a transverse axis, and a lateral axis (1110). In an embodiment, the gain medium is a gain slab (also referred to as an amplifier slab) that has a thickness (measured along the longitudinal axis) that is smaller than the width and length (measured along the transverse and lateral axes, respectively). The method also includes pumping the gain medium (1112) and directing light through the gain medium along the longitudinal axis (1114). The light is amplified in the gain medium (1116) and the gain medium is cooled such that the gain medium is characterized by a first temperature (1118). In an embodiment, the first temperature is a cryogenic temperature less than room temperature, such as 150K, 200K, or the like.

The method also includes producing ASE in the gain medium (1120). The ASE propagates along the transverse axis and the lateral axis. The method further includes directing the ASE through a waveguide optically coupled to the gain medium (1122). The waveguide is transparent in some embodiments, with more than 90% of the ASE being transmitted through the waveguide. The waveguide can partially surround the gain medium along directions aligned with the transverse axis and the lateral axis, enabling optical access to the faces of the gain medium normal to the longitudinal axis. In some embodiments, the waveguide is made from the same host material as the gain medium, but without the active species (e.g., Yb).

Additionally, the method includes absorbing a portion of the ASE in an edge cladding optically coupled to the waveguide (1124). The cladding is characterized by a second temperature higher than the first temperature. The second temperature can be room temperature. Since the cladding is thermally insulated from the gain medium by the waveguide, the temperature of the cladding can be maintained at a higher temperature than the gain medium during operation.

It should be appreciated that the specific steps illustrated in FIG. 11 provide a particular method of operating an optical amplifier according to an embodiment of the present invention. Other sequences of steps may also be performed according to alternative embodiments. For example, alternative embodiments of the present invention may perform the steps outlined above in a different order. Moreover, the individual steps illustrated in FIG. 11 may include multiple sub-steps that may be performed in various sequences as appropriate to the individual step. Furthermore, additional steps may be added or removed depending on the particular applications. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A laser amplifier system comprising:
a gain medium characterized by a first temperature during operation and the cladding is characterized by a second temperature greater than the first temperature during operation.

2. The laser amplifier system of claim 1 wherein the second temperature is substantially room temperature.

3. The laser amplifier system of claim 1 wherein the gain medium has a longitudinal axis and a plurality of sides substantially parallel to the longitudinal axis.

4. The laser amplifier system of claim 1 wherein the gain medium comprises a rectangular slab having a width and length orthogonal to the longitudinal axis greater than a thickness measured along the longitudinal axis.

5. The laser amplifier system of claim 1 wherein the gain medium comprises at least one of Yb:YAG or Yb:CaF₂.

6. The laser amplifier system of claim 1 further comprising:
a waveguide having:
a plurality of inner surfaces, each of the inner surfaces being optically coupled to one of the plurality of sides of the gain medium; and
a plurality of outer surfaces; and
a cladding optically coupled to the outer surfaces of the waveguide.

7. The laser amplifier system of claim 6 wherein the gain medium is operable to amplify light at a gain wavelength.

8. The laser amplifier system of claim 7 wherein the waveguide is substantially transparent at the gain wavelength.

9. The laser amplifier system of claim 7 wherein the cladding is absorbing at the gain wavelength.

10. The laser amplifier system of claim 5 wherein the waveguide is tapered such that the inner surfaces are characterized by a first surface area and the outer surfaces are characterized by a second surface area less than the first surface area.

11. A reflective optical amplifier comprising:
a gain element having an input/output side and a back side, the gain element comprising:
a gain medium having a width, a length, and a thickness less than the width and the length;
a waveguide partially surrounding the gain medium; and
an edge absorber partially surrounding the waveguide;
a reflective element disposed adjacent the back side; and
a cooling element disposed adjacent the reflective element.

12. The reflective optical amplifier of claim 11 wherein the gain medium comprises an ytterbium active species.

13. The reflective optical amplifier of claim 12 wherein the gain medium comprises at least one of a YAG or a CaF₂ host crystal.

14. The reflective optical amplifier of claim 11 wherein the gain medium comprises an active species disposed in a host crystal and the waveguide comprises the host crystal.

15. The reflective optical amplifier of claim 14 wherein the edge absorber comprises an absorbing species in the host crystal.

16. The reflective optical amplifier of claim 11 wherein the reflective elements comprises a dielectric stack mirror.

17. The reflective optical amplifier of claim 11 wherein cooling element comprises a cooling face having a spatial dimension approximately equal to the width times the length.

18. The reflective optical amplifier of claim 11 wherein the gain medium is characterized by a first temperature during operation and the edge absorber is characterized by a second temperature greater than the first temperature during operation.

19. The reflective optical amplifier of claim 18 wherein the second temperature is substantially room temperature.

20. An optical amplifier system comprising:
a set of amplifier units arrayed along a longitudinal direction, wherein each of the amplifier units comprises:
a gain slab operable to amplify light propagating along the longitudinal direction and produce ASE along a transverse direction and a lateral direction, the transverse direction being orthogonal to the longitudinal direction and the lateral direction being orthogonal to the longitudinal direction and the transverse direction;
a waveguide optically coupled to peripheral portions of the gain slab;
a set of reflectors optically coupled to the waveguide and operable to reflect ASE propagating along the transverse direction;
a set of cooling vanes, each being coupled to one of the reflectors and operable to direct a cooling fluid flowing along the transverse direction; and
one or more absorptive edge claddings optically coupled to the waveguide and operable to absorb ASE propagating along the lateral direction; and
a cooling system operable to provide a coolant flow along the transverse direction.

21. The optical amplifier system of claim 20 wherein a thickness of the waveguide is substantially equal to a thickness of the gain slab.

22. The optical amplifier system of claim 20 wherein the set of reflectors comprise a high reflectivity dielectric mirror at a wavelength of the ASE.

23. The optical amplifier system of claim 20 wherein the gain medium comprises ytterbium.

24. The optical amplifier system of claim 23 wherein the gain medium comprises at least one of YAG or CaF₂.

25. The optical amplifier system of claim 20 wherein the ASE propagating along the lateral direction includes ASE reflected from the set of reflectors.

26. The optical amplifier system of claim 20 wherein set of cooling vanes comprises a same material as the waveguide.

27. The optical amplifier system of claim 20 further comprising one or more transverse flow barriers disposed between the amplifier units.

28. The optical amplifier system of claim 20 wherein the waveguides are tapered in the transverse direction.

29. A method of operating a laser amplifier, the method comprising:
providing a gain medium having a longitudinal axis, a transverse axis, and a lateral axis;
pumping the gain medium;
directing light through the gain medium along the longitudinal axis;
amplifying the light in the gain medium;
cooling the gain medium such that the gain medium is characterized by a first temperature;
producing ASE in the gain medium, wherein the ASE propagates along the transverse axis and the lateral axis;
directing the ASE through a waveguide optically coupled to the gain medium; and
absorbing a portion of the ASE in an edge cladding optically coupled to the waveguide, wherein the cladding is characterized by a second temperature higher than the first temperature.

30. The method of claim 29 wherein the gain medium comprises a gain slab including terbium.

31. The method of claim 29 wherein the waveguide comprises an optical element characterized by transmission greater than 90% at wavelengths associated with the ASE.

32. The method of claim 29 wherein the waveguide partially surrounds the gain medium along directions aligned with the transverse axis and the lateral axis.

33. The method of claim 29 wherein the gain medium comprises a host material.

34. The method of claim 33 wherein the waveguide comprises the host material.

35. The method of claim 29 wherein host material comprises at least one of YAG or CaF₂.

36. The method of claim 35 wherein the waveguide comprises at least one of YAG or CaF₂.

37. The method of claim 29 wherein the first temperature is less than room temperature.

38. The method of claim 37 wherein the first temperature is less than or equal to 200K.

39. The method of claim 29 wherein second temperature is room temperature.
